(19) United States
(12) Patent Application Publication
(10) Pub. No.: US 2010/0166035 A1
(43) Pub. Date: Jul. 1, 2010

(54) TEMPERATURE MEASURING DEVICE

(76) Inventor: Jang-Hyun Yoon, Gangseo-gu (KR)

Correspondence Address: SHERR & VAUGHN, PLLC, 620 HERNDON PARKWAY, SUITE 320, HERNDON, VA, 20170, US

(21) Appl. No.: 12/646,528

(22) Filed: Dec. 23, 2009

(30) Foreign Application Priority Data
Dec. 30, 2008 (KR) 10-2008-0137600

(51) Int. Cl. G01K 7/00

(52) U.S. Cl. 374/170; 327/512; 374/E07.001

(57) ABSTRACT

A temperature measuring device includes an IPTAT generator for generating an IPTAT for generating a band gap reference voltage, and a voltage forwarder for generating an analogous temperature voltage corresponding to a mirror current which is a mirrored current of the IPTAT, thereby permitting to embody the temperature measuring device with SOC techniques using a digital CMOS process such that the temperature measuring device occupies small overall area.

The present application claims priority under 35 U.S.C. §119 to Korean Patent Application No. 10-2008-0137600 (filed on Dec. 30, 2008), which is hereby incorporated by reference in its entirety.

### BACKGROUND

As illustrated in FIG. 1, a block diagram of a temperature measuring device that includes temperature sensor 10 and sigma delta convertor 12. Temperature sensor 10 is a CMOS transistor that generates a voltage proportional to a temperature by using a particular device. However, the temperature measuring device employing temperature sensor 10 has a problem in having a high production cost due to the process of manufacturing a CMOS. Sigma delta convertor 12 can be an analog-to-digital convertor (ADC), a successive approximation register (SAR) convertor or a dual slope convertor. Such a temperature measuring device also exhibits high power consumption, and occupies a large circuit area, making it difficult to produce the temperature measuring device as a system-on-chip (SOC).

FIG. 2 illustrates a block diagram of another temperature measuring device that includes first oscillator 20, second oscillator 22 and frequency voltage converter 24. First oscillator 20 makes sensitive oscillation in accordance with a temperature. Second oscillator 22 makes non-sensitive oscillation in accordance with the temperature. Therefore, frequency voltage convertor 24 converts and forwards a difference of oscillation frequencies of first oscillator 20 and second oscillator 22. Accordingly, the temperature measuring device as illustrated in FIG. 2 measures the temperature using the difference between the frequencies oscillating varied with the temperature. However, the mobility of a MOS transistor of first oscillator 20 and second oscillator 22 is dependent on the temperature, thereby failing to make the difference of the two frequencies fixed with respect to the temperature. Accordingly, the temperature measuring device illustrated in FIG. 2 cannot provide an accurate temperature.

### SUMMARY

Embodiments are related to a temperature measuring device which can embody an integrated circuit (IC) or MOS transistors.

Embodiments are related to a temperature measuring device which enables accurate measurement of a temperature and occupies a small area in a digital CMOS process.

In accordance with embodiments, a temperature measuring device can include at least one of the following: an IPTAT generator for generating an IPTAT for generating a band gap reference voltage, and a voltage forwarder for generating an analogous temperature voltage corresponding to a mirror current which is a mirrored current of the IPTAT.

In accordance with embodiments, a temperature measuring device can include at least one of the following: an IPTAT generator configured to generate a current for a band gap reference voltage, the IPTAT generator including a first MOS transistor, a MOS transistor, a third MOS transistor, a fourth MOS transistor, a fifth MOS transistor, a MOS transistor M6, a first transistor, a second resistor, a first capacitor, a first bipolar transistor, a second bipolar transistor and an operational amplifier; a voltage forwarder configured to generate an analogous temperature voltage corresponding to a mirror current of the IPTAT, the voltage generator including a seventh MOS transistor, a third resistor and a fourth resistor; and analog/digital converter configured to convert the analogous temperature voltage into a digitized temperature voltage.

In accordance with embodiments, a temperature measuring device can include at least one of the following: an IPTAT generator configured to generate a current for a band gap reference voltage, the IPTAT generator including a first MOS transistor, a MOS transistor, a third MOS transistor, a fourth MOS transistor, a fifth MOS transistor, a sixth MOS transistor, a first transistor, a second resistor, a first capacitor, a first bipolar transistor, a second bipolar transistor and an operational amplifier; a voltage forwarder configured to generate an analogous temperature voltage corresponding to a mirror current of the IPTAT, the voltage generator including a seventh MOS transistor, a third resistor and a fourth resistor, and an analog/digital converter configured to convert the analogous temperature voltage into a digitized temperature voltage, the analog/digital converter including an SAR logic unit, a digital/analog converter, a comparator, 2ⁿ resistors and a switching box.

### DRAWINGS

FIGS. 1 and 2 illustrate a temperature measuring device.

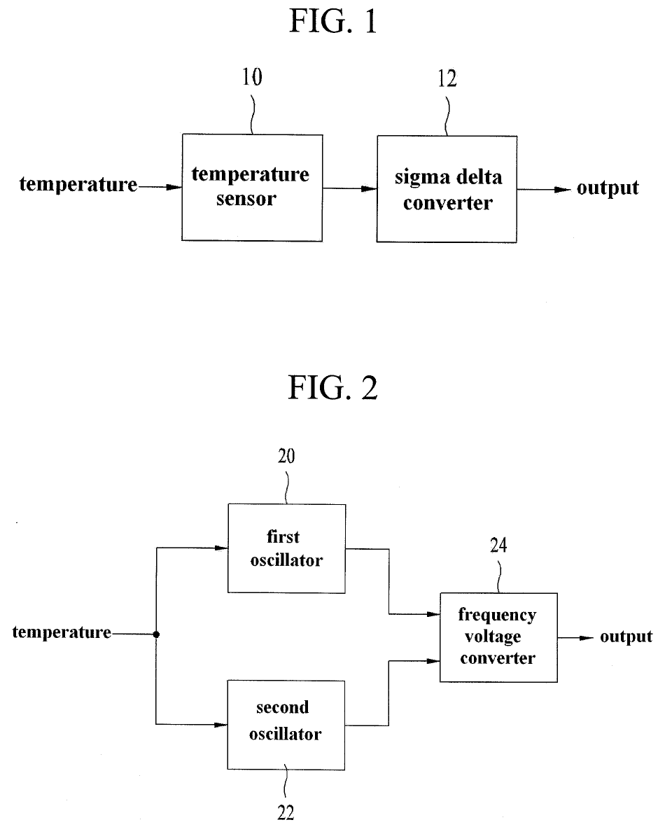

Example FIGS. 3 to 7 illustrates a temperature measuring device, in accordance with embodiments.

### DESCRIPTION

Reference will now be made in detail to embodiments, examples of which are illustrated in the accompanying drawings. Wherever possible, the same reference numbers will be used throughout the drawings to refer to the same or like parts.

Example FIG. 3 illustrates a block diagram of a temperature measuring device in accordance with embodiments schematically, including IPTAT generator 100 which produces current proportional to absolute temperature, voltage forwarder 200, and analog-to-digital converter (ADC) 300.

As illustrated in example FIG. 3, IPTAT generator 100 generates current IPTAT that is proportional to a temperature, i.e., increases in accordance with a temperature, and forwards the IPTAT generated to voltage forwarder 200. Voltage forwarder 200 generates an analogous temperature voltage VTEMP corresponding to a mirror current I_{L} which is a mirrored current of the IPTAT. The temperature measuring device in accordance with embodiments measures temperature by mirroring the IPTAT which increases in accordance with the measured temperature.

IPTAT generator 100 and voltage forwarder 200 can be embodied in a variety of manners. For example, in accordance with embodiments, IPTAT generator 100 and voltage forwarder 200 can be embodied in a type of a band gap reference generator (BRG). Meaning, IPTAT generator 100 and voltage forwarder 200 can generate analogous temperature voltage VTEMP using the IPTAT required for generation of a band gap reference voltage.

As illustrated in example FIG. 3, the temperature measuring device in accordance with embodiments may also include analog-to-digital converter (ADC) 300. ADC 300 digitizes analogous temperature voltage VTEMP from voltage forwarder 200, and forwards temperature voltage VTEMP digitized through output terminal OUT1.

Example FIG. 4 illustrates a circuit diagram of an IPTAT generator and a voltage forwarder in accordance with embodiments.

As illustrated in example FIG. 4, IPTAT generator 100A includes first MOS transistor M1, second MOS transistor M2, third MOS transistor M3, fourth MOS transistor M4, fifth MOS transistor M5 and sixth MOS transistor M6, first transistor R1 and second resistor R2, first capacitor C1, first bipolar transistor Q1 and second bipolar transistor Q2, and operational amplifier 110.

First bipolar transistor Q1 includes a collector and an emitter connected between first feed back voltage V_{FB1} and ground, and a base connected to the collector. Second bipolar transistor Q2 includes a collector and an emitter connected between second feed back voltage V_{FB2} and ground, and a base connected to the collector.

First resistor R1 is connected between first feed back voltage V_{FB1} and the collector of first bipolar transistor Q1.

Operational amplifier 110 has negative and positive input terminals connected to first feed back voltage V_{FB1} and second feed back voltage V_{FB2}, respectively. Each of first MOS transistor M1, second MOS transistor M2 and third MOS transistor M3 has a gate connected to an output terminal of operational amplifier 110, and a source connected to supply voltage VC1. Fourth MOS transistor M4 has a source connected to supply voltage VC1 and a gate connected to a drain of first MOS transistor M1. Fifth MOS transistor M5 has a source and a drain connected between the drain of fourth MOS transistor M1 and second feed back voltage V_{FB2} respectively and a gate connected to bias voltage BIASP0. Bias voltage BIASP0 can have a level between supply voltage VC1 and a ground voltage, which is enough to turn on fifth MOS transistor M5. Sixth MOS transistor M6 has a drain and a source connected between the drain of first MOS transistor M1 and the ground respectively, and a gate connected to bias voltage BIASN0. Bias voltage BIASN0 can have a level between supply voltage VC1 and the ground voltage, which is enough to turn on sixth MOS transistor M5.

First capacitor C1 is connected to the drain and the source of sixth MOS transistor M6 respectively, and second resistor R2 is connected between the drain of third MOS transistor M3 and first feed back voltage V_{FB1}. The IPTAT flows through second resistor R2, and can be expressed as an equation 1, below.

$$IPTAT = \frac{In ( m ) {V}_{T}}{R 1} \qquad ( 1 )$$

where V_{T} denotes a thermal voltage of second bipolar transistor Q2, m denotes a ratio of a number of first bipolar transistors Q1 to a number of second bipolar transistors Q2, and a ratio of a size of the first bipolar transistor to a size of second bipolar transistor Q is 1:N. Referring to equation 1, an absolute value of the IPTAT is fixed by resistor R1 and ratio m of numbers of the bipolar transistors, and a slope of the current versus the temperature is fixed by a ratio of the In(m) to resistor R1.

Voltage forwarder 200A includes seventh MOS transistor M7, and third resistor R3 and fourth resistor R4. Seventh MOS transistor M7 includes a source connected to supply voltage VC1, and a gate connected to an output terminal of operational amplifier 110. Third resistor R3 is connected between the drain of seventh MOS transistor M7 and analogous temperature voltage VTEMP. Fourth resistor R4 is connected between analogous temperature voltage VTEMP and the ground. Current I_{L} having the IPTAT mirrored thereto, i.e., copied, flows through third resistor R3 and fourth resistor R4. Voltage forwarder 200A having such a configuration copies the IPTAT and forwards the IPTAT to third resistor R3. Therefore, analogous temperature voltage VTEMP which is a voltage drop at third resistor R3 can be expressed as an equation 2, shown below.

$$VTEMP = R 4 \times {I}_{L} = \frac{R 4}{R 1} I ( m ) {V}_{T} \qquad ( 2 )$$

Referring to equation 2, analogous temperature voltage VTEMP has component V_{T} which increases with temperature. In this instance, temperature voltage VTEMP is a voltage having a fixed slope with respect to temperature changes. Meaning, since temperature voltage VTEMP is fixed by a resistor ratio R4/R1, making it not sensitive to a process variation, stable production of temperature voltage VTEMP can be made.

Example FIG. 5 illustrates a block diagram of an ADC in accordance with embodiments, which includes clock generator 310, successive approximation register (SAR) logic unit 320, DAC 340 and comparator 360.

As illustrated in example FIG. 5, clock generator 310 receives clock signal CK from an outside of clock generator 310, converts the clock signal into clock signal CLK having a frequency or a period suitable to the device illustrated in example FIG. 5, and forwards the converted clock signal CLK to successive approximation register (SAR) logic unit 320, DAC 340 and comparator 360.

SAR logic unit 320 performs the following operation in response to start signal START. SAR logic unit 320 forwards a digitized temperature voltage having a preset level through output terminal OUT2 in response to comparing signal COMP0 from comparator 360. Meaning, SAR logic unit 320 fixes values of the digitized temperature voltage from most significant bit (MSB) thereof to least significant bit (LSB) thereof in accordance with a level of comparing signal COMP0 in response to clock signal CLK. For example, it is assumed that the digitized temperature voltage is expressed with 8 bits (b₇, b₆, b₅, b₄, b₃, b₂, b₁, and b₀), where b₇ is MSB, and b₀ is LSB. SAR logic unit 320 fixes levels of bits (b₇, b₆, b₅, b₄, b₃, b₂, b₁, and b₀) in accordance with the level of comparing signal COMP0 whenever the level of clock signal CLK is triggered. In detail, all of bits (b₇, b₆, b₅, b₄, b₃, b₂, b₁, and b₀) have initial values of “0.” Then, if the level of comparing signal COMP0 is “1” when clock signal CLK is triggered, b₇ is fixed as “1.” Then, if the level of comparing signal COMP0 is “0” when clock signal CLK is triggered, b₆ is fixed as “0.” In accordance with such operations, levels of bits (b₇, b₆, b₅, b₄, b₃, b₂, b₁, and b₀) can be fixed.

DAC 340 coverts the digitized temperature voltage from SAR logic unit 320 into the analogous temperature voltage, and forwards the analogous temperature voltage to comparator 360.

Example FIG. 6 illustrates a circuit diagram of a DAC in accordance with embodiments, which includes a string of 2ⁿ resistors R and switching box 342.

As illustrated in example FIG. 6, string of 2ⁿ resistors R are connected in series between top level REFT and bottom level REFB of a reference voltage. Switching box 342 switches voltages of different levels taken out between adjacent resistors of 2ⁿ resistors R in response to the digitized temperature voltage, and forwards an analogous temperature voltage which is a result of the switching to comparator 360 through output terminal OUT3. Switching box 342 can include a plurality of switches each switched in response to the digitized temperature voltage. Each of the switches can include an MOS transistor such that the digitized temperature voltage is applied to the gate of the MOS transistor.

Comparator 360 compares an output from DAC 340 to analogous temperature voltage VTEMP from voltage forwarder 200 illustrated in example FIG. 3, and forwards a result of the comparison as comparing signal COMP0. Comparator 360 can take the form of an auto zero comparator (AZC).

Example FIG. 7 illustrates a circuit diagram of a comparator in accordance with embodiments.

As illustrated in example FIG. 7, comparator 360A includes second capacitor C2, third capacitor C3 and fourth capacitor C4, first inverting transistor M11, second inverting transistor M12, third inverting transistor M21, fourth inverting transistor M22, fifth inverting transistor M31, sixth inverting transistor M32, first switching unit 362, second switching unit 364, third switching unit 366, fourth switching unit 368, first switch inverter 370, second switch inverter 372, and inverter 374.

As illustrated in example FIG. 7, second capacitor C2 is connected between first terminal N1 and second terminal N2. Third capacitor C3 is connected between third terminal N3 and second terminal N2. Second capacitor C2 can have capacitance eight times the capacitance of third capacitor C3.

First switching unit 362 switches between analogous temperature voltage VTEMP and first terminal N1. Second switching unit 364 switches between an output from DAC 340 received through input terminal IN2 and first terminal N1 in response to inverted clock signal CLKB. Third switching unit 366 switches between an output from DAC 340 received through input terminal IN2 and third terminal N3 in response to clock signal CLK. Fourth switching unit 368 switches between bottom level REFB of the reference voltage and third terminal N3 in response to inverted clock CLKB.

First switching inverter 370 inverts or bypasses a voltage at second terminal N2 in response to clock signal CLK. To do this, first switch inverter 370 can include fifth switching unit 371 and CMOS transistors M11 and M12. Fifth switching unit 371 is switched in response to clock signal CLK. If fifth switching unit 371 is switched on, the voltage at node N2 is bypassed toward second switching inverter 372. However, if fifth switching unit 371 is switched off, the voltage at node N2 is inverted by CMOS transistors M1 and M2 and forwarded toward second switching inverter 372.

Fourth capacitor C4 is connected between first switching inverter 370 and second switching inverter 372. Second switching inverter 372 inverts or bypasses a voltage provided thereto from first switching inverter 370 via fourth capacitor C4. To do this, second switching inverter 372 can include sixth switching unit 373 and CMOS transistors M21 and M22. Sixth switching unit 373 is switched in response to clock signal CLK. If sixth switching unit 373 is switched on, the voltage provided thereto from first switching inverter 370 via fourth capacitor C4 is bypassed toward inverter 374. However, if sixth switching unit 373 is switched off, the voltage provided from first switching inverter 370 via fourth capacitor C4 is inverted at CMOS transistors M21 and M22, and forwarded to inverter 374. Inverter 374, which can include CMOS transistors M31 and M32, inverts an output from second switching inverter 372, and forwards a result of the inversion as comparing signal COMP0.

In the meantime, it is assumed that the digitized temperature voltage from ADC 300 or 300A is expressed with eight bits (b₇, b₆, b₅, b₄, b₃, b₂, b₁, and b₀). In this case, digitized temperature voltage Vadc converted from analogous temperature voltage VTEMP can be expressed with an equation 3, below.

$$Vadc = [ \frac{1}{2} {b}_{7} + \frac{1}{4} {b}_{6} + \frac{1}{8} {b}_{5} + \frac{1}{16} {b}_{4} + \frac{1}{8} ( \frac{1}{4} {b}_{3} + \frac{1}{8} {b}_{2} + \frac{1}{16} {b}_{1} + \frac{1}{32} {b}_{0} ) ] \qquad ( 3 )$$

where V_{FS} is a value obtained by subtracting bottom level REFB from upper level REFT of the reference voltage.

DAC 340 in FIG. 5 has 5(=n) bits of string resistors as illustrated in example FIG. 6, and comparator 360 illustrated in example FIG. 5 is scaling capacitor C2 as illustrated in example FIG. 7. If capacitance of second capacitor C2 is eight times the capacitance of third capacitor C3, 256 resistors generally required for an 8 bit ADC can be reduced to 32 resistors using scaling capacitor C2. This is because the capacitance of second capacitor C2 is eight times the capacitance of third capacitor C3, ⅛ can be multiplied to b₃/4+b₂/8+b₁/16+b₀/32.

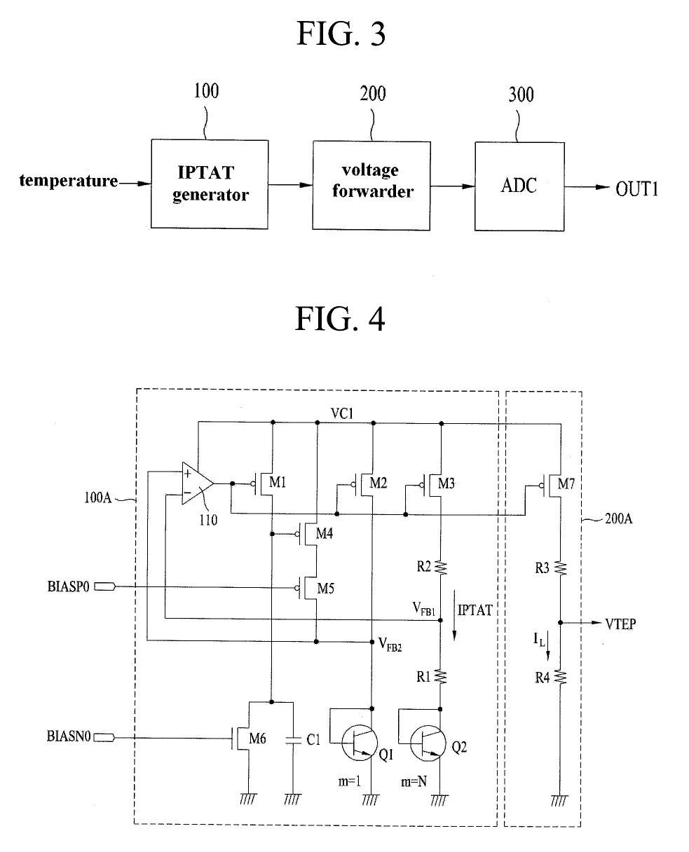

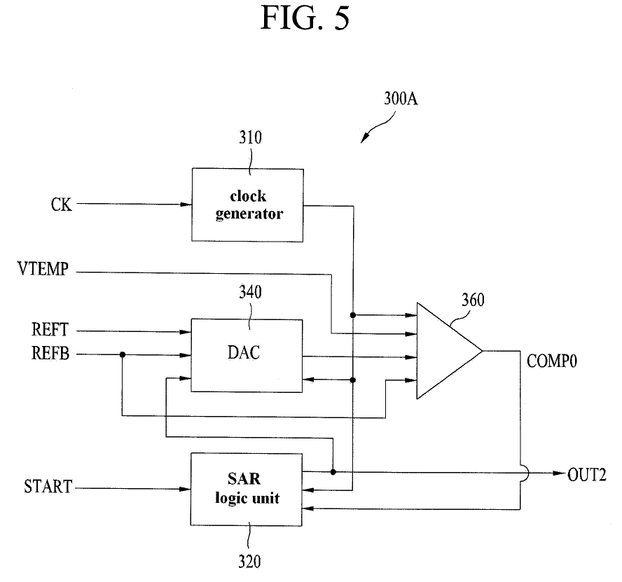

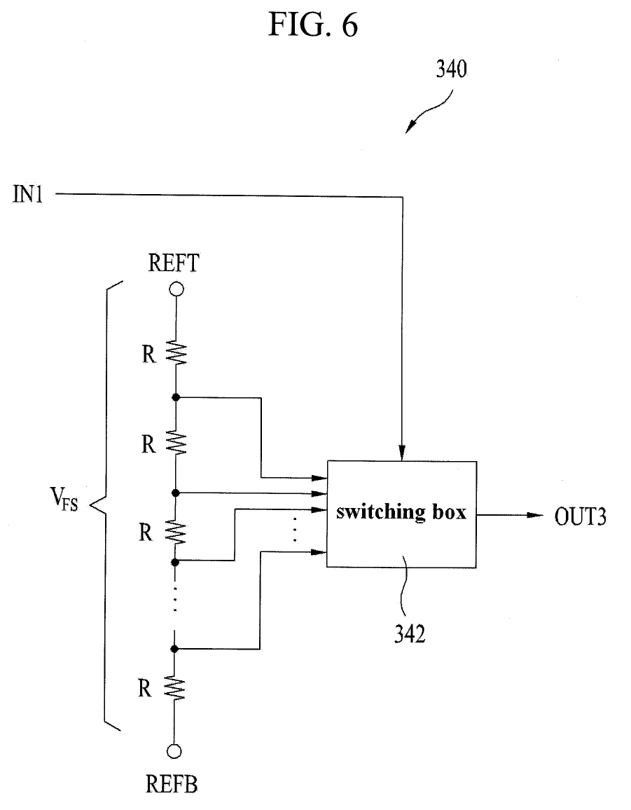

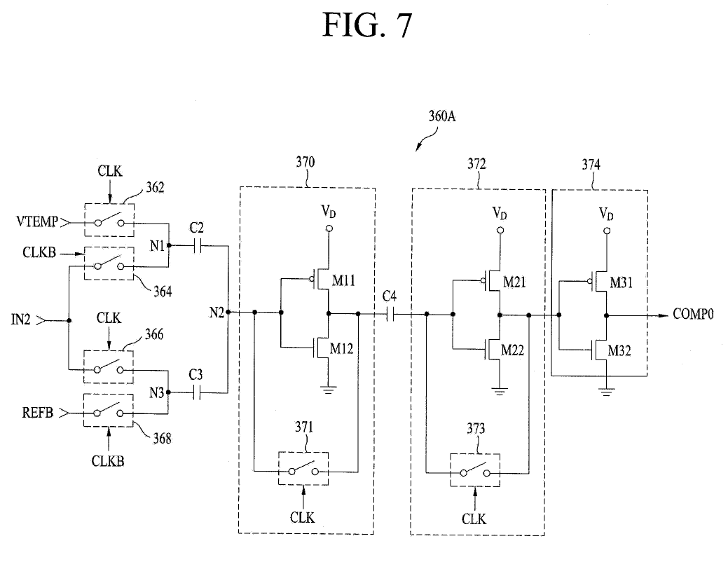

In accordance with embodiments, eventually, ADC 300 illustrated in example FIG. 3, an SAR type that includes the string resistors illustrated in example FIG. 2 and scaling second capacitor C2, reduces an area of the temperature sensor used in the ADC using DAC 340, thereby permitting a substantial reduction in the overall area of ADC 300. This enables the temperature measuring device to be embodied as a system-on-chip (SOC).

Accordingly, the temperature measuring device in accordance with embodiments occupies a small area permitting it to be incorporated as an SOC by a digital CMOS process, and secures an accurate measurement of a temperature.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus comprising:
an IPTAT generator configured to generate a current for a band gap reference voltage; and
a voltage forwarder configured to generate an analogous temperature voltage corresponding to a mirror current of the IPTAT.

2. The apparatus of claim 1, wherein the IPTAT generator comprises:
a first bipolar transistor having a collector and an emitter connected between a first feed back voltage and ground, and a base connected to the collector; and
a second bipolar transistor having a collector and an emitter connected between a second feed back voltage and ground, and a base connected to the collector.

3. The apparatus of claim 2, wherein the IPTAT generator comprises:
a first resistor connected between the first feed back voltage and the collector of the first bipolar transistor.

4. The apparatus of claim 3, wherein the IPTAT generator comprises:
an operational amplifier negative and positive input terminals connected to the first feed back voltage and the second feed back voltage, respectively.

5. The apparatus of claim 4, wherein the IPTAT generator comprises:
first, second and third MOS transistors each having a gate connected to an output terminal of the operational amplifier, and a source connected to a supply voltage;
a fourth MOS transistor having a source connected to the supply voltage and a gate connected to a drain of the first MOS transistor;
a fifth MOS transistor having a source and a drain connected between the drain of the fourth MOS transistor and the second feed back voltage respectively and a gate connected to a bias voltage; and
a sixth MOS transistor having a drain and a source connected between the drain of the first MOS transistor and the ground respectively, and a gate connected to the bias voltage.

6. The apparatus of claim 5, wherein the IPTAT generator comprises:
a first capacitor connected to the drain and the source of the sixth MOS transistor respectively; and
a second resistor connected between the third MOS transistor and the first feed back voltage.

7. The apparatus of claim 6, wherein the voltage forwarder comprises:
a seventh MOS transistor having a source connected to the supply voltage, and a gate connected to an output terminal of the operational amplifier;
a third resistor connected between the drain of the seventh MOS transistor and the analogous temperature voltage; and
a fourth resistor connected between the analogous temperature voltage and the ground.

8. The apparatus of claim 1, further comprising an analog/digital converter configured to convert the analogous temperature voltage into a digitized temperature voltage.

9. The apparatus of claim 8, wherein the analog/digital converter comprises:
an SAR logic unit configured to forward a digitized temperature voltage having a preset level in response to a comparing signal;
a digital/analog converter configured to convert the digitized temperature voltage from the SAR logic unit into the analogous temperature voltage; and
a comparator configured to compare an output from the digital/analog converter to the analogous temperature voltage, and forward a result of the comparison as the comparing signal.

10. The apparatus of claim 9, wherein the digital/analog converter comprises:
2ⁿ resistors connected in series between a top level and a bottom level of a reference voltage; and
a switching box configured to switch voltages of different levels taken out between adjacent resistors of the 2ⁿ resistors in response to the digitized temperature voltage.

11. The apparatus of claim 9, wherein the SAR logic unit fixes values of the most significant bit to the least significant bit of the digitized temperature voltage in accordance with a level of the comparing signal in response to a clock signal.

12. The apparatus of claim 10, wherein the comparator comprises:
a second capacitor connected between a first terminal and a second terminal; and
a third capacitor connected between a third terminal and a second terminal.

13. The apparatus of claim 12, wherein the comparator comprises:
a first switching unit configured to switch between the analogous temperature voltage and the first terminal;
a second switching unit configured to switch between an output from the DAC and the first terminal in response to an inverted clock signal;
a third switching unit configured to switch between an output from the DAC and a third terminal in response to a clock signal; and
a fourth switching unit configured to switch between the bottom level of the reference voltage and the third terminal in response to the inverted clock.

14. The apparatus of claim 13, wherein the comparator comprises:
a first switching inverter configured to one of invert and bypass a voltage at the second terminal in response to the clock signal; and
a second switching inverter configured to one of invert and switching an output from the first switching inverter in response to the clock signal.

15. The apparatus of claim 14, wherein the comparator comprises:
a fourth capacitor connected between the first switching inverter and the second switching inverter; and
an inverter configured to invert an output from the second switching inverter and forwarding a result of the inversion as the comparing signal.

16. The apparatus of claim 1, wherein the apparatus comprises a temperature measuring device.

17. An apparatus comprising:
an IPTAT generator configured to generate a current for a band gap reference voltage, the IPTAT generator comprising a first MOS transistor, a MOS transistor, a third MOS transistor, a fourth MOS transistor, a fifth MOS transistor, a sixth MOS transistor, a first transistor, a second resistor, a first capacitor, a first bipolar transistor, a second bipolar transistor and an operational amplifier;
a voltage forwarder configured to generate an analogous temperature voltage corresponding to a mirror current of the IPTAT, the voltage generator comprising a seventh MOS transistor, a third resistor and a fourth resistor; and
an analog/digital converter configured to convert the analogous temperature voltage into a digitized temperature voltage.

18. The apparatus of claim 17, wherein the apparatus comprises a temperature measuring device.

19. An apparatus comprising:
an IPTAT generator configured to generate a current for a band gap reference voltage, the IPTAT generator comprising a first MOS transistor, a MOS transistor, a third MOS transistor, a fourth MOS transistor, a fifth MOS transistor, a sixth MOS transistor, a first transistor, a second resistor, a first capacitor, a first bipolar transistor, a second bipolar transistor and an operational amplifier;
a voltage forwarder configured to generate an analogous temperature voltage corresponding to a mirror current of the IPTAT, the voltage generator comprising a seventh MOS transistor, a third resistor and a fourth resistor; and
an analog/digital converter configured to convert the analogous temperature voltage into a digitized temperature voltage, the analog/digital converter comprising an SAR logic unit, a digital/analog converter, a comparator, 2ⁿ resistors and a switching box.

20. The apparatus of claim 19, wherein the apparatus comprises a temperature measuring device.
